(19) United States
(12) Patent Application Publication
(10) Pub. No.: US 2002/0189648 A1
(43) Pub. Date: Dec. 19, 2002

(54) Method and apparatus for cleaning electrical probes

(75) Inventors: Steven Engelking, San Antonio, TX (US); Hien Nguyen, San Antonio, TX (US)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation

(21) Appl. No.: 09/881,061

(22) Filed: Jun. 15, 2001

(51) Int. Cl. B08B 3/02; B08B 9/00

(52) U.S. Cl. 134/22.18; 134/34; 134/198; 134/172; 134/167 R; 134/104.4

(57) ABSTRACT

An apparatus and method for cleaning needle probe tips includes a spray nozzle that is shaped to fit in a needle-tip aperture formed by a plurality of needle probes. The spray nozzle includes a plurality of openings through which a fluid can be sprayed onto the probe tips to blast debris off of the probe tips. The openings preferably spray fluid at differing angles to ensure that debris is removed from the entire probe tip surface.

### BACKGROUND OF THE INVENTION

1. Field of the Invention

The present invention relates to cleaning electrical probes, and more particularly to an on-board cleaning method and apparatus for removing debris from electrical probe needles.

2. Description of the Related Art

In the semiconductor industry, integrated circuits (ICs) typically undergo basic functional testing on a wafer before they are mounted onto a device that will connect the circuitry to electronic equipment. This testing process often involves using probe machines and probe cards to check numerous dies (ranging from 200 to 2,000, or more) on a silicon wafer. The dies, if they are not rejected, are cut apart and mounted on package devices.

Many conventional testing machines use a probe card that contacts the silicon wafer circuitry during basic functional testing. The probe card typically contains 16 to 500 or more probe needles set at an angle relative to the plane defined by the surface of the wafer. The wafer is mounted on a chuck and is contacted by the probe card. This contact and other environmental factors introduce debris, such as metal, polymers and organo-metallic materials, into the probe card. As debris accumulates, the performance of the probe card can be adversely affected. More particularly, the build-up of debris on the probe needles may lead to high contact resistance and false test results, causing good dies to be discarded unnecessarily and resulting in decreased yields. Thus, to maintain proper functioning of the probe card, the probe needle tips should be cleaned periodically to remove any accumulated debris.

Burnishing is one method for removing debris from needle probes and involves rubbing or scraping the needle probes to dislodge debris. In some conventional probe polishing assemblies, a chuck descends and a stage holding the chuck and the probe polishing assembly moves to place a burnishing pad under the probe card. The burnishing pad is then placed on a position suitable for polishing the probe needles. The burnishing pad then burnishes the probe needle tips by moving the burnishing pad against the XY-plane of the contact surface between the pad and the probe needle tips. After the probe card needle tips are polished, the burnishing assembly and the stage return to their original position, allowing wafer probing to continue.

Using a burnishing pad for debris removal does have some limitations, however. Because debris tends to collect on the front of the probe needle tips, typical burnishing pads are not be able to reach all of the surfaces where debris has collected. As a result, the only currently known way to completely remove debris is to interrupt the testing process, remove the probe card from the testing device and immerse the probe needles in a solution, such as isopropyl alcohol, in an ultrasonic bath or manually brush the needle probes. Removing the probe card is a time-consuming procedure and increases the likelihood of small deformations in the probe needles. Further, burnishing pads require precise alignment between the pad and the needle probe to ensure that the burnishing process removes debris without bending the needle probes. This alignment process is time-consuming and further increases the down-time of the testing equipment. Additionally, burnishing friction may wear the probe needle tips, shortening the life of the probe card.

There is a need for a probe cleaning assembly and method that does not encounter the problems noted above with previously known cleaning systems.

### SUMMARY OF THE INVENTION

Accordingly, the present invention is directed to an apparatus for removing debris from one or more probe needle tips, comprising a spray nozzle having a plurality of openings disposed on the spray nozzle through which a spray fluid is output onto the probe needle tips to remove debris. In one embodiment, the spray fluid is sprayed in different directions along the spray nozzle to ensure spray uniformity.

The invention is also directed to a method for removing debris from a plurality of probe needles grouped to form a needle-tip aperture, comprising the steps of positioning a spray nozzle in the needle tip aperture and spraying a spray fluid through a plurality of apertures in a shaft portion of the spray nozzle. As a result, the invention provides thorough cleaning of the needle probe surfaces without relying on physical contact between the cleaning apparatus and the surface, ensuring that debris is removed from the entire probe needle tip to minimize false test results.

### BRIEF DESCRIPTION OF THE DRAWINGS

FIG. 1 is a perspective view of a system incorporating the inventive cleaning apparatus;

FIGS. 2A and 2B are top and side views, respectively, of the inventive cleaning apparatus;

FIG. 3 is a cross-sectional view of the inventive cleaning apparatus taken along line 3-3 in FIG. 2A; and

FIGS. 4A and 4B are representative diagrams illustrating the operation of the inventive cleaning apparatus.

### DESCRIPTION OF THE PREFERRED EMBODIMENTS

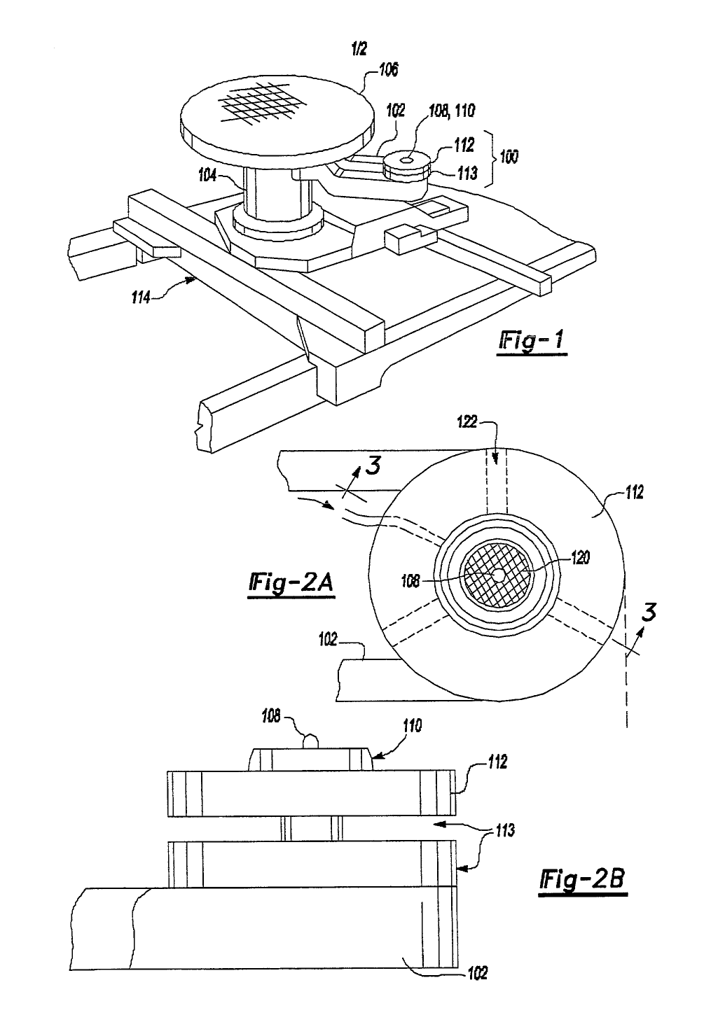

FIG. 1 is a perspective view of an assembly incorporating a probe card needle cleaning apparatus 100 according to the present invention, and FIGS. 2A and 2B are top and side views, respectively, of the probe card needle cleaning apparatus 100. As can be seen in the Figures, the cleaning apparatus 100 is disposed on a support arm 102 that is connected to a chuck 104 disposed underneath the wafer 106 to be tested. The apparatus includes a spray nozzle 108 supported by a nozzle holder 110, which is in turn contained in a housing 112 on the support arm 102. A pneumatic cylinder 113 is disposed below the housing 112 so that the apparatus 100 can be raised and lowered with respect to the probe needles to be cleaned All of the components are supported on a stage 114 so that the chuck 104 and components connected to the chuck 104 can be moved relative to the wafer 106 by the stage 114.

FIG. 3 is a side cross-sectional view of the inventive apparatus 100 when it is positioned for cleaning a plurality of probe needles 115. As can be seen in the Figure, the plurality of probe needles 115 together form a needle tip aperture 116. The spray nozzle 108 fits in the needle tip aperture 116 during the cleaning process. Also, as can be seen in the figure, the nozzle holder 110 has an optional recessed portion 118 to capture debris as it is removed from the probe needles 115. To ease in cleaning the apparatus 100, a capturing device 120, such as a removable debris-capturing pad, can be placed in the recessed portion 118 to trap the debris. Alternatively, a suction attachment (not shown), such as a suction tube with one opening disposed in the recessed portion 118 and a conduit similar to the fluid conduit described below can be used to remove debris from the recessed portion 118.

To secure the spray nozzle 108 to the chuck 104, the nozzle holder 110 is placed in the housing 112 and secured with set screws 122 as well as a vertical screw 124 that descends into the housing 112. The nozzle holder 110 is preferably made of a rigid material, such as ceramic, and shaped in the form of a truncated sphere to provide a convex surface that makes more optimal contact with concave surfaces formed in the distal ends of the set screws 122 to minimize any slippage.

A conduit 126 connects the spray nozzle 108 with an fluid source (not shown) so that fluid can be forced through openings in the nozzle 108. The fluid can be either liquid or vapor, and can be, for example, a cleaning fluid or pressurized vapor. The specific fluid reservoirs, pump mechanisms, and valve layouts that can be used with the spray nozzle 108 do not form a part of the invention and can have any configuration desired by the user.

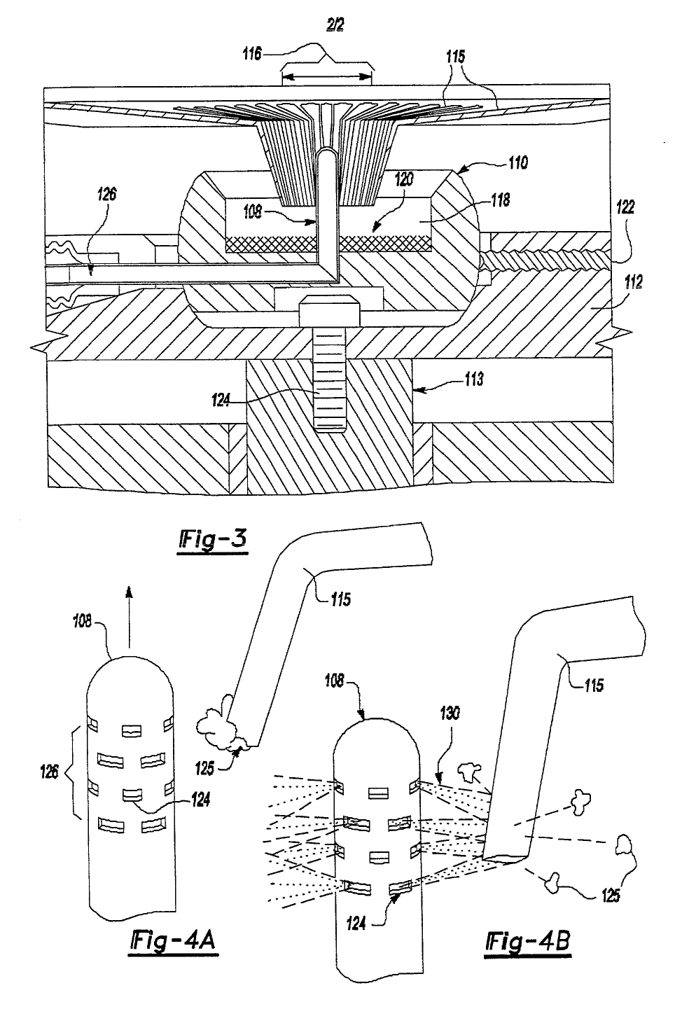

FIGS. 4A and 4B are simplified diagrams illustrating the manner in which the inventive spray nozzle 108 operates. For clarification purposes only, FIGS. 4A and 4B show the process for cleaning a single probe needle 115; however, in practice, the inventive apparatus 100 can clean multiple probe needles 115 simultaneously. As can be seen in the Figures, debris 125 tends to accumulate on the needle aperture side of the probe needle tip 115. The spray nozzle 108 has a plurality of spray holes 124 that are disposed primarily on a shaft portion 126 of the nozzle 108. The spray holes 124 can be in any desired arrangement; however, a helical or spiral arrangement is preferred. Additionally, the angle in which the spray holes 124 are cut into the shaft portion can direct the spray angle of the fluid output through the holes. In one embodiment, the spray holes 124 that lie closer to the tip 128 of the spray nozzle 108 are cut to spray in a downward direction, while the spray holes 124 that are further down the shaft portion 126 are cut to spray in an upward direction. By angling the spray holes 124 to focus the spray direction toward a more central location, the resulting spray pattern from the spray nozzle 108 is aimed toward the critical surfaces on the probe needles 115 that collect debris 125. A multi-directional spray pattern ensures that the spray will reach all debris-covered surfaces on the probe needles 115. During the cleaning process, the spray nozzle 108 itself does not physically touch any portion of the probe needles 115, making precise alignment between the spray nozzle 108 and the probe needles 115 unnecessary.

Note that the invention is not limited to the above-described spray hole and spray angle configuration and can be customized according to the user's preferences. Further, the spray nozzle 108 itself does not have to be cylindrical, as shown in the Figure, but can have any desired shape desired by the user. In addition, the shape of the other components in the assembly 100 can be modified to provide additional functional characteristics. For example, the walls of the spray nozzle holder 110 can have a tapered shape to catch and contain the spray material 130 as it is output from the spray holes 124.

To clean a probe card, the chuck 104 descends and the stage 114 moves to place the cleaning assembly 100 under the probe card. The pneumatic cylinder 113 then lifts the spray nozzle 108 to a position suitable for cleaning the probe needles 115, such as in the needle tip aperture 116. A spray fluid 130, such as pressurized vapor or liquid, is then output through the spray holes 124 onto the probe needle surfaces, as shown in FIG. 4B, to dislodge and remove debris 125 from the surfaces. During the spraying process, the spray nozzle 108 can be programmed or otherwise controlled to move up and down (in the Z-direction) relative to the probe needles 115 to provide further cleaning action. Because the spray angle of the spray holes 124 along the shaft 126 vary, the vertical movements of the spray nozzle 108 ensures that the fluid 130 is sprayed uniformly over the probe needle surface 115. The debris that is blasted off of the probe needles 115 by the spray 130 is caught by the filter 120 in the spray nozzle holder 110, which is periodically removed and cleaned or replaced.

As a result, the invention provides thorough cleaning of the probe needle tips without requiring direct contact between the cleaning apparatus and the probe needle. The invention can be adapted for cleaning multiple probe cards, if desired.

While the invention has been specifically described in connection with certain specific embodiments thereof, it is to be understood that this is by way of illustration and not of limitation, and the scope of the appended claims should be construed as broadly as the prior art will permit.

What is claimed is:

1. An apparatus for removing debris from an electrical probe, comprising:
a spray nozzle; and
a plurality of openings disposed on the spray nozzle through which a spray fluid is output onto the electrical probe to remove debris.

2. The apparatus of claim 1, further comprising a support member coupled to the spray nozzle, wherein the support member has a surface defined at least in part by a truncated sphere.

3. The apparatus of claim 2, further comprising a plurality of set screws for retaining the support member, each set screw having a concave surface located at a distal end to create intimate contact with the surface of the support member.

4. The apparatus of claim 1, further comprising a controller coupled to the spray nozzle for changing the position of the spray nozzle relative to the electrical probe.

5. The apparatus of claim 4, wherein the controller moves the spray nozzle in at least one of a vertical direction and a horizontal direction in the needle tip aperture while the spray fluid is being output.

6. The apparatus of claim 1, wherein the spray nozzle has a shaft portion, and wherein the plurality of openings in the spray nozzle are disposed in a spiral arrangement around the shaft portion.

7. The apparatus of claim 6, wherein the plurality of openings in the shaft portion are disposed such that the spray fluid is output from different openings in different directions.

8. The apparatus of claim 7, wherein the openings near a top portion of the shaft direct the spray fluid downwardly and the openings near a bottom portion of the shaft direct the spray fluid upwardly.

9. The apparatus of claim 1, wherein the plurality of openings in the spray nozzle are disposed such that the spray fluid is output from different openings in different directions.

10. The apparatus of claim 9, wherein the openings near a top portion of the spray nozzle direct the spray fluid downwardly and the openings near a bottom portion of the spray nozzle direct the spray fluid upwardly.

11. The apparatus of claim 1, further comprising a capturing device that captures debris removed from the electrical probe.

12. The apparatus of claim 11, wherein the capturing device is a removable capturing pad.

13. The apparatus of claim 11, wherein the capturing device is a suction attachment.

14. The apparatus of claim 1, wherein the spray nozzle is configured to fit in a needle tip aperture formed by a plurality of electrical probes on a probe card.

15. An apparatus for removing debris from a plurality of electrical probes, comprising:
a spray nozzle having a shaft portion that is configured to fit in a needle-tip aperture formed by the plurality of electrical probes;
a plurality of openings disposed on the shaft portion in a spiral fashion; and
a controller coupled to the spray nozzle for changing the position of the spray nozzle relative to the electrical probe by moving the spray nozzle in at least one of a vertical direction and a horizontal direction in the needle tip aperture while the spray fluid is being output.

16. The apparatus of claim 15, further comprising:
a support member coupled to the spray nozzle, wherein the support member has a surface defined at least in part by a truncated sphere; and
a plurality of set screws for retaining the support member, each set screw having a concave surface located at a distal end to create intimate contact with the surface of the support member.

17. The apparatus of claim 15, wherein the plurality of openings in the shaft portion are disposed such that the spray fluid is output from different openings in different directions.

18. The apparatus of claim 17, wherein the openings near a top portion of the shaft direct the spray fluid downwardly and the openings near a bottom portion of the shaft direct the spray fluid upwardly.

19. The apparatus of claim 15, further comprising a capturing device that captures debris removed from the electrical probes.

20. The apparatus of claim 19, wherein the capturing device is a removable capturing pad.

21. The apparatus of claim 19, wherein the capturing device is a suction attachment.

22. A method for removing debris from a plurality of electrical probes grouped to form a needle-tip aperture, comprising the steps of:
positioning a spray nozzle in the needle tip aperture; and
spraying a spray fluid through a plurality of openings in a shaft portion of the spray nozzle.

23. The method of claim 22, further comprising the step of moving the spray nozzle in at least one of a vertical direction and a horizontal direction within the needle tip aperture during the spraying step.

24. The method of claim 23, wherein the spraying step is conducted by spraying fluid from different openings in different directions.

25. The method of claim 24, wherein the spraying step is conducted by directing the spray fluid downwardly through openings near a top portion of the shaft and directing the spray fluid upwardly through near a bottom portion of the shaft.
